(19) United States
(12) Patent Application Publication
(10) Pub. No.: US 2022/0076101 A1
(43) Pub. Date: Mar. 10, 2022

(54) OBJECT FEATURE INFORMATION ACQUISITION, CLASSIFICATION, AND INFORMATION PUSHING METHODS AND APPARATUSES

(71) Applicant: ALIPAY (HANGZHOU) INFORMATION TECHNOLOGY CO., LTD., Hangzhou (CN)

(72) Inventors: Shuo YANG, Hangzhou (CN); Zhiqiang ZHANG, Hangzhou (CN); Shaosheng CAO, Hangzhou (CN); Jun ZHOU, Hangzhou (CN)

(21) Appl. No.: 17/361,363

(22) Filed: Jun. 29, 2021

(30) Foreign Application Priority Data
Sep. 4, 2020 (CN) 202010922527.5

(51) Int. Cl. G06N 3/04; G06K 9/62

(52) U.S. Cl. CPC G06N 3/0454; G06K 9/6296; G06K 9/6288; G06K 9/6215

(57) ABSTRACT

Object feature information acquisition methods, systems, and devices, including computer programs encoded on computer storage media are provided. One of the methods includes: obtaining N relation networks of N time instances, wherein each of the relation networks comprises a plurality of nodes and connection relationships between the nodes, and each of the relation networks comprises a first node representing a first user; determining (i) a spatial aggregation feature of the first node at a first time instance and (ii) a node feature of the first node; inputting N spatial aggregation features of the N time instances into a sequential neural network; determining, based on an output result of the sequential neural network, N spatio-temporal expressions of the first node at the N time instances; and aggregating the N spatio-temporal expressions to obtain a spatio-temporal aggregation feature of the first node as feature information of the first user.

### CROSS-REFERENCE TO RELATED APPLICATION

This application claims priority to the Chinese patent application No. 202010922527.5 filed on Sep. 4, 2020, and entitled “OBJECT FEATURE INFORMATION ACQUISITION, CLASSIFICATION, AND INFORMATION PUSHING METHODS AND APPARATUSES,” which is incorporated herein by reference in its entirety.

### TECHNICAL FIELD

This specification relates to the technical field of graph computation, and in particular, to object feature information acquisition, object classification, and information pushing methods and devices.

### BACKGROUND

In the era of big data, a large amount of object relationship data may be acquired, from which a relation network for multiple objects may be constructed, and nodes are used to represent objects. For example, a relation network for objects such as users and/or products may be constructed. For a relation network graph, an embedding vector for each vector in the relation network may be typically computed through a graph embedding algorithm based on initial features of the nodes and the connection relationships between the nodes, thereby obtaining deeper feature information of the objects. The feature information of the objects is represented by a vector having preset dimensions. After the feature information of each object is acquired, various applications may be implemented. For example, based on the similarity between feature information of objects, a product purchased by one user may be used for recommending a product to another user, and the like.

Conventional graph embedding algorithms typically compute an embedding vector of each node (feature information of the object) based on the initial features of the nodes of the relation network at a certain time instance (for example, a time instance closer to the current time instance). However, the relation network itself is dynamically changing. For example, in a social relationship graph, as new friendship relationships are continuously being formed while existing friendship relationships might be deleted, the structure of the relation network may be different at different time instances. Therefore, using a structural network information at only one time instance to determine the feature information of each object cannot fully utilize information from a previous dynamic structural change of the network.

Therefore, a more effective solution of using the relation network to obtain the feature information of the objects is desired.

### SUMMARY

One or more embodiments of this specification describe object feature information acquisition, object classification, and information pushing methods and devices to use object feature information through a relation network more effectively. The technical solutions are described as follows.

In a first aspect, an embodiment provides a spatio-temporal aggregation-based object feature information acquisition method executable by a computer, the method comprising: acquiring N relation networks of N time instances, the relation networks comprising a plurality of nodes and connection relationships between the nodes, the N relation networks each comprising a first node, and the nodes representing objects; respectively determining, in the N relation networks, a plurality of neighbor nodes of the first node, and obtaining N neighbor node groups respectively corresponding to the N time instances for the first node; determining, for any first time instance among the N time instances, a spatial aggregation feature of the first node at the first time instance based on a node feature of each neighbor node in a neighbor node group corresponding to the first time instance and a node feature of the first node; inputting, in accordance with a temporal order, N spatial aggregation features of the N time instances into a sequential neural network as a sequence, and determining, at least based on an output result of the sequential neural network, N spatio-temporal expressions of the first node at the N time instances; and aggregating the N spatio-temporal expressions to obtain a spatio-temporal aggregation feature of the first node as feature information of a first object represented by the first node.

In some embodiments, the step of determining the spatial aggregation feature of the first node at the first time instance comprises: inputting the node feature of each neighbor node in the neighbor node group corresponding to the first time instance and the node feature of the first node into a graph neural network to obtain the spatial aggregation feature of the first node at the first time instance.

In some embodiments, the step of determining the spatial aggregation feature of the first node at the first time instance comprises: determining, through an attention mechanism-based adaptive breadth function and based on the node feature of each neighbor node in the neighbor node group corresponding to the first time instance and the node feature of the first node, an importance level of each neighbor node relative to the first node; performing, based on the importance level corresponding to each neighbor node, weighted summation on the node feature of each neighbor node to obtain a breadth feature of the first node; and performing, through a loop operator-based adaptive depth function, t-step iterations on the first node based on the breadth feature to obtain the spatial aggregation feature of the first node at the first time instance.

In some embodiments, the step of determining, at least based on the output result of the sequential neural network, the N spatio-temporal expressions of the first node at the N time instances comprises: determining, through the sequential neural network, N temporal aggregation features of the first node at the N time instances; and correspondingly combining the spatial aggregation features and the temporal aggregation features of the N time instances to respectively obtain the spatio-temporal expressions of the corresponding time instances.

In some embodiments, the step of correspondingly combining the spatial aggregation features and the temporal aggregation features of the N time instances comprises: concatenating, in accordance with a preset method, a spatial aggregation feature and a temporal aggregation feature of any time instance, and using a corresponding feature obtained from the concatenation as a spatio-temporal expression of the corresponding time instance.

In some embodiments, the step of aggregating the N spatio-temporal expressions comprises aggregating the N spatio-temporal expressions based on a self-attention mechanism.

In some embodiments, the step of aggregating the N spatio-temporal expressions based on the self-attention mechanism comprises: constructing a spatio-temporal expression matrix from the spatio-temporal expressions of the N time instances; determining an attention matrix based on the self-attention mechanism and the N spatio-temporal expressions; obtaining a second transformation matrix based on a product of the attention matrix and a first transformation matrix, the first transformation matrix being a product of the spatio-temporal expression matrix and a pre-trained first parameter matrix; and determining, based on concatenation of each vector in the second transformation matrix, the spatio-temporal aggregation feature of the first node.

In some embodiments, the graph neural network comprises a graph convolutional neural network (GCN), a graph attention neural network (GAN), a GraphSage network, or a Geniepath network.

In some embodiments, the sequential neural network comprises a long short-term memory (LSTM) or a recurrent neural network (RNN).

In some embodiments, the objects comprise at least one of the following types: a user, a product, a shop, and a region.

In some embodiments, a temporal aggregation feature of any one of the time instances is obtained based on aggregating the spatial aggregation features of one or more time instances before said time instance.

In a second aspect, an embodiment provides a spatio-temporal aggregation-based object classification method executable by a computer, the method comprising: acquiring feature information of a second object, wherein the feature information of the second object is acquired through the method of the first aspect; and inputting the feature information of the second object into a pre-trained object classifier to obtain a classification result of the second object.

In a third aspect, an embodiment provides a spatio-temporal aggregation-based information pushing method executable by a computer, the method comprising: acquiring feature information of a third object and feature information of a fourth object, the feature information of the third object and the feature information of the fourth object being separately acquired through the method of the first aspect; and pushing, if a similarity level between the feature information of the third object and the feature information of the fourth object is greater than a preset similarity threshold, information to the fourth object based on information of interest for the third object.

In a fourth aspect, an embodiment provides a spatio-temporal aggregation-based connection relationship predicting method executable by a computer, the method comprising: acquiring feature information of a fifth object and feature information of a sixth object, the feature information of the fifth object and the feature information of the sixth object being separately acquired through the method of the first aspect; concatenating the feature information of the fifth object and the feature information of the sixth object to obtain a concatenation feature; and inputting the concatenation feature into a pre-trained connection relationship classifier to obtain a classification result of whether a connection relationship exists between the fifth object and the sixth object.

In a fifth aspect, an embodiment provides a spatio-temporal aggregation-based object feature information acquisition device implemented in a computer, the device comprising: a network acquisition module, configured to acquire N relation networks of N time instances, the relation networks comprising a plurality of nodes and connection relationships between the nodes, the N relation networks each comprising a first node, and the nodes representing objects; a neighbor determining module, configured to respectively determine, in the N relation networks, a plurality of neighbor nodes of the first node, and obtaining N neighbor node groups respectively corresponding to the N time instances for the first node; a spatial aggregation module, configured to determine, for any first time instance among the N time instances, a spatial aggregation feature of the first node at the first time instance based on a node feature of each neighbor node in a neighbor node group corresponding to the first time instance and a node feature of the first node; a spatio-temporal expression module, configured to input, in accordance with a temporal order, N spatial aggregation features of the N time instances into a sequential neural network as a sequence, and determine, at least based on an output result of the sequential neural network, N spatio-temporal expressions of the first node at the N time instances; and a spatio-temporal aggregation module, configured to aggregate the N spatio-temporal expressions to obtain a spatio-temporal aggregation feature of the first node as feature information of a first object represented by the first node.

In some embodiments, the spatial aggregation module is further configured to: input the node feature of each neighbor node in the neighbor node group corresponding to the first time instance and the node feature of the first node into a graph neural network to obtain the spatial aggregation feature of the first node at the first time instance.

In some embodiments, the spatial aggregation module is further configured to: determine, through an attention mechanism-based adaptive breadth function and based on the node feature of each neighbor node in the neighbor node group corresponding to the first time instance and the node feature of the first node, an importance level of each neighbor node relative to the first node; perform, based on the importance level corresponding to each neighbor node, weighted summation on the node feature of each neighbor node to obtain a breadth feature of the first node; and perform, through a loop operator-based adaptive depth function, t-step iterations on the first node based on the breadth feature to obtain the spatial aggregation feature of the first node at the first time instance.

In some embodiments, the spatio-temporal expression module is further configured to perform, when determining, at least based on the output result of the sequential neural network, the N spatio-temporal expressions of the first node at the N time instances, the following operation: determining, through the sequential neural network, N temporal aggregation features of the first node at the N time instances; and correspondingly combining the spatial aggregation features and the temporal aggregation features of the N time instances to respectively obtain the spatio-temporal expressions of the corresponding time instances.

In some embodiments, the spatio-temporal expression module is further configured to perform, when correspondingly combining the spatial aggregation features and the temporal aggregation features of the N time instances, the following operation: concatenating, in accordance with a preset method, a spatial aggregation feature and a temporal aggregation feature of any time instance, and using a corresponding feature obtained from the concatenation as a spatio-temporal expression of the corresponding time instance.

In some embodiments, the spatio-temporal aggregation module is further configured to aggregate the N spatio-temporal expressions based on a self-attention mechanism.

In some embodiments, the spatio-temporal aggregation module is further configured to perform, when aggregating the N spatio-temporal expressions based on the self-attention mechanism, the following operations: constructing a spatio-temporal expression matrix from the spatio-temporal expressions of the N time instances; determining an attention matrix based on the self-attention mechanism and the N spatio-temporal expressions; obtaining a second transformation matrix based on a product of the attention matrix and a first transformation matrix, the first transformation matrix being a product of the spatio-temporal expression matrix and a pre-trained first parameter matrix; and determining, based on concatenation of each vector in the second transformation matrix, the spatio-temporal aggregation feature of the first node.

In some embodiments, the graph neural network comprises a graph convolutional neural network (GCN), a graph attention neural network (GAN), a GraphSage network, or a Geniepath network.

In some embodiments, the sequential neural network comprises a long short-term memory (LSTM) or a recurrent neural network (RNN).

In some embodiments, the objects comprise at least one of the following types: a user, a product, a shop, and a region.

In some embodiments, a temporal aggregation feature of any one of the time instances is obtained based on aggregating the spatial aggregation features of one or more time instances before said time instance.

In a sixth aspect, an embodiment provides a spatio-temporal aggregation-based object classification device implemented in a computer, the device comprising: a first acquisition module, configured to acquire feature information of a second object, wherein the second object is acquired through the method of the first aspect; and an object classification module, configured to input the feature information of the second object into a pre-trained object classifier to obtain a classification result of the second object.

In a seventh aspect, an embodiment provides a spatio-temporal aggregation-based information pushing device implemented in a computer, the device comprising: a second acquisition module, configured to acquire feature information of a third object and feature information of a fourth object, the feature information of the third object and the feature information of the fourth object being separately acquired through the method of the first aspect; and an information pushing module, configured to push, if a similarity level between the feature information of the third object and the feature information of the fourth object is greater than a preset similarity threshold, information to the fourth object based on information of interest for the third object.

In an eighth aspect, an embodiment provides a spatio-temporal aggregation-based connection relationship prediction device implemented in a computer, the device comprising: a third acquisition module, configured to acquire feature information of a fifth object and feature information of a sixth object, the feature information of the fifth object and the feature information of the sixth object being separately acquired through the method of the first aspect; a feature concatenation module, configured to concatenate the feature information of the fifth object and the feature information of the sixth object to obtain a concatenation feature; and a relationship classification module, configured to input the concatenation feature into a pre-trained connection relationship classifier to obtain a classification result of whether a connection relationship exists between the fifth object and the sixth object.

In a ninth aspect, an embodiment provides a computer-readable storage medium having a computer program stored thereon; and when the computer program is executed in a computer, the computer is caused to execute the method of any one of the first aspect to the fourth aspect.

In a tenth aspect, an embodiment provides computing equipment comprising a memory and a processor; executable code is stored in the memory, and when executing the executable code, the processor implements the method of any one of the first aspect to the fourth aspect.

The specification further provides another object feature information acquisition method executable by a computer, the method comprising: obtaining N relation networks of N time instances, wherein the N time instances have a temporal order, each of the relation networks corresponds to a time instance of the N time instances and comprises a plurality of nodes and connection relationships between the nodes, and each of the relation networks comprises a first node representing a first user; determining (i) a spatial aggregation feature of the first node at a first time instance and (ii) a node feature of the first node, wherein the node feature of the first node comprises an attribute feature, a historical activity feature, an association relationship feature, an interaction feature, or a physical indicator feature; inputting, in accordance with the temporal order, N spatial aggregation features of the N time instances into a sequential neural network; determining, based on an output result of the sequential neural network, N spatio-temporal expressions of the first node at the N time instances; and aggregating the N spatio-temporal expressions to obtain a spatio-temporal aggregation feature of the first node as feature information of the first user.

The specification also provides another object feature information acquisition device. The device comprises one or more processors and a non-transitory computer-readable memory coupled to the one or more processors and configured with instructions executable by the one or more processors to perform operations. The operations may include: obtaining N relation networks of N time instances, wherein the N time instances have a temporal order, each of the relation networks corresponds to a time instance of the N time instances and comprises a plurality of nodes and connection relationships between the nodes, and each of the relation networks comprises a first node representing a first user; determining (i) a spatial aggregation feature of the first node at a first time instance and (ii) a node feature of the first node, wherein the node feature of the first node comprises an attribute feature, a historical activity feature, an association relationship feature, an interaction feature, or a physical indicator feature; inputting, in accordance with the temporal order, N spatial aggregation features of the N time instances into a sequential neural network; determining, based on an output result of the sequential neural network, N spatio-temporal expressions of the first node at the N time instances; and aggregating the N spatio-temporal expressions to obtain a spatio-temporal aggregation feature of the first node as feature information of the first user.

The specification further provides a non-transitory computer-readable storage medium, which stores instructions executable by one or more processors to cause the one or more processors to perform operations. The operations may include: obtaining N relation networks of N time instances, wherein the N time instances have a temporal order, each of the relation networks corresponds to a time instance of the N time instances and comprises a plurality of nodes and connection relationships between the nodes, and each of the relation networks comprises a first node representing a first user; determining (i) a spatial aggregation feature of the first node at a first time instance and (ii) a node feature of the first node, wherein the node feature of the first node comprises an attribute feature, a historical activity feature, an association relationship feature, an interaction feature, or a physical indicator feature; inputting, in accordance with the temporal order, N spatial aggregation features of the N time instances into a sequential neural network; determining, based on an output result of the sequential neural network, N spatio-temporal expressions of the first node at the N time instances; and aggregating the N spatio-temporal expressions to obtain a spatio-temporal aggregation feature of the first node as feature information of the first user.

According to the methods and devices provided in the embodiments of this specification, multiple spatial aggregation features of a node are acquired from relation networks of multiple time instances; spatio-temporal expressions of the node at the multiple time instances are determined through a sequential neural network based on a sequence constituted by the multiple spatial aggregation features; and a spatio-temporal aggregation feature of the node is obtained based on aggregating the multiple spatio-temporal expressions. The spatio-temporal aggregation feature of the node aggregates node features at different time instances in the relation network, and at the same time, spatial dimension information and temporal dimension information of the node is used, thereby improving the relevance of the determined object feature information.

### BRIEF DESCRIPTION OF THE DRAWINGS

In order to illustrate the technical solutions of the embodiments of this specification more clearly, the accompanying drawings to be used in the description of the embodiments will be briefly described below. Apparently, the accompanying drawings in the following description are some embodiments of this specification, and those of ordinary skills in the art may further derive other accompanying drawings from these accompanying drawings without inventive efforts.

FIG. 1 is a schematic flowchart of an implementation according to an embodiment of this specification;

FIG. 2 is a schematic flowchart of a spatio-temporal aggregation-based object feature information acquisition method according to an example embodiment of this specification;

FIG. 3 is a schematic flowchart of a spatio-temporal aggregation-based object classification method according to an example embodiment of this specification;

FIG. 4 is a schematic flowchart of a spatio-temporal aggregation-based information pushing method according to an example embodiment of this specification;

FIG. 5 is a schematic flowchart of a spatio-temporal aggregation-based connection relationship predicting method according to an example embodiment of this specification;

FIG. 6 is a schematic block diagram of a spatio-temporal aggregation-based object feature information acquisition device according to an example embodiment of this specification;

FIG. 7 is a schematic block diagram of a spatio-temporal aggregation-based object classification device according to an example embodiment of this specification;

FIG. 8 is a schematic block diagram of a spatio-temporal aggregation-based information pushing device according to an example embodiment of this specification; and

FIG. 9 is a schematic block diagram of a spatio-temporal aggregation-based connection relationship predicting device according to an example embodiment of this specification.

### DETAILED DESCRIPTION

The solutions provided by this specification are described below with reference to the accompanying drawings.

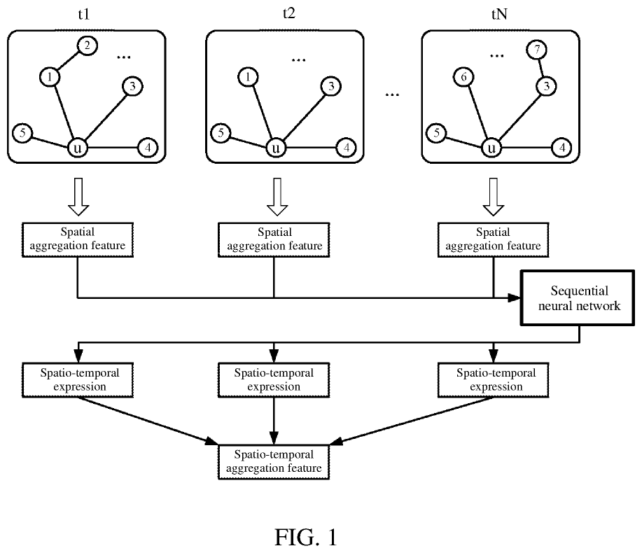

FIG. 1 is a schematic flowchart of an implementation according to an embodiment of this specification. FIG. 1 shows relation networks at multiple time instances t1, t2, . . . , tN. The nodes and node connection relationships in these relation networks are examples to facilitate understanding of the aspects, instead of limiting the embodiments of this specification. The relation networks may also be referred to as relation network graphs, graph networks, etc. For a certain node in the relation networks, a spatial aggregation feature of the node may be determined based on any of the relation networks. Multiple spatial aggregation features of the node are inputted, in accordance with a temporal order, into a sequential neural network as a sequence. A spatio-temporal expression of the node at each of the time instances is determined at least based on an output result of the sequential neural network. Spatio-temporal expressions of the multiple time instances are aggregated to obtain a spatio-temporal aggregation feature of the node, which is feature information of the node. The feature information of any node in the relation networks can be determined through the above-described techniques. The above-described feature information combines spatial dimension information of the node in the relation networks and temporal dimension information of the relation networks at multiple time instances, thereby fully utilizing information of a previous dynamic structural change of the relation networks, and achieving extraction of deeper and more relevant feature information of the node.

The nodes in the above-described relation networks represent objects. The objects may include at least one of the following types: a user, a product, a shop, a region, and the like. The relation networks may comprise multiple nodes and connection relationships between the nodes. If an association relationship exists between two nodes, a connecting edge is established between the nodes. The relation networks may be a homogeneous relation network, which means that only one single type of nodes is present; and the nodes may be any of users, products, shops, and regions. In some embodiments, when the nodes represent users, the association relationship between users may be a wire transfer relationship, a communication relationship, a file transmission relationship, a mail sending and receiving relationship, etc. The relation networks may also be a heterogeneous relation network. That is, multiple types of nodes are present. For example, the nodes may include at least two of the following: users, products, shops, regions, etc. In some embodiments, nodes may include users, products, shops, and regions. A connecting edge corresponding to a purchase relationship may exist between a node corresponding to a user and a node corresponding to a product; a connecting edge corresponding to an affiliation relationship may exist between a node corresponding to a product and a node corresponding to a shop; and a connecting edge corresponding to an affiliation relationship may exist between a node corresponding to a shop or a node corresponding to a user and a node corresponding to a region. Various similar examples exist, and are not elaborated herein.

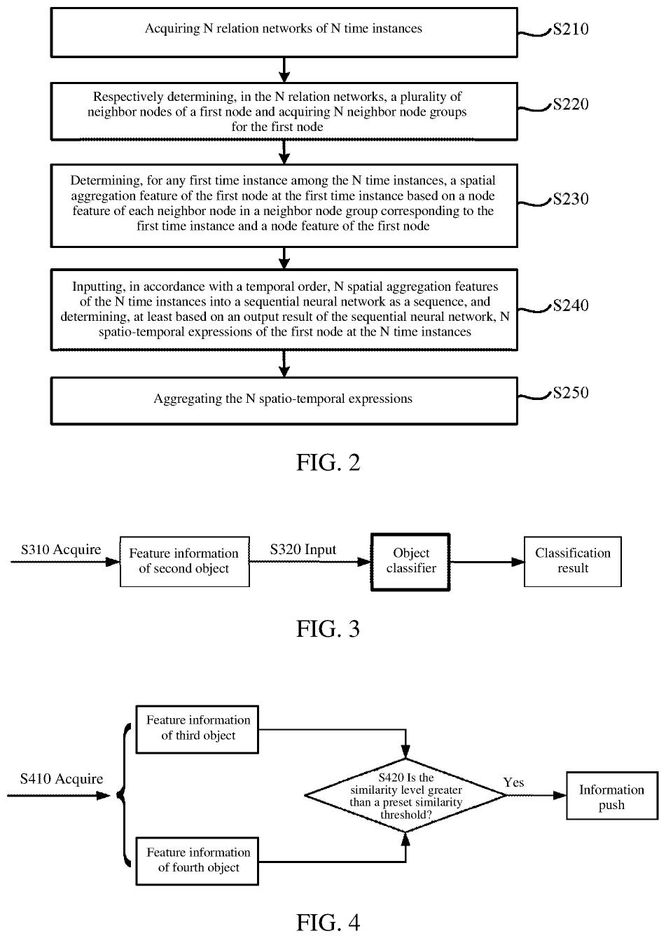

At different time instances, the connection relationship between nodes may change, and initial features of nodes may also change. Correspondingly, multiple nodes constitute different relation networks at different time instances. Using the method provided by the embodiments of this specification to acquire object feature information causes features to be extracted from relation networks in both the spatial dimensions and the temporal dimension, thereby obtaining more accurate and relevant feature information of objects. A detailed description is provided below in conjunction with the embodiment shown in FIG. 2.

FIG. 2 is a schematic flowchart of a spatio-temporal aggregation-based object feature information acquisition method provided by an example embodiment. The method is executable by a computer, and the computer may be implemented by any equipment, platform, or device cluster having computing and processing capacities. The method includes steps S210 to S250 as follows.

Step S210 is acquiring N relation networks of N time instances, the relation networks comprising a plurality of nodes and connection relationships between the nodes, the N relation networks each comprising a first node, and the nodes representing objects. The “first” in the afore-mentioned first node and the corresponding “first” below are for the convenience of distinction and description, and shall not be construed as limiting in any way. The first node may be any node in the relation networks. N may be a preset integer greater than 1. The N time instances may be, for example, t1, t2, t3, . . . , tN, and may be multiple time instances separated apart by a constant time interval, or multiple time instances without a regular time interval. The connection relationships between node features and/or the nodes in the relation networks may be different at different time instances.

Acquiring the N relation networks of the N time instances may be acquiring the node features corresponding to each of the N time instances and the connection relationships between the nodes; and the relation networks at the corresponding time instances are generated based on the node features and the connection relationships between the nodes respectively corresponding to the N time instances.

Step S220 is respectively determining, in the N relation networks, a plurality of neighbor nodes of the first node, and obtaining N neighbor node groups respectively corresponding to the N time instances for the first node.

In some embodiments, when N is 3, and for the relation network of time instance t1, the relation network of time instance t2, and the relation network of time instance t3, the neighbor nodes of the first node determined from the relation network of time instance t1 include node 3, node 4, node 5, node 1, and node 2, which constitute a neighbor node group of time instance t1. The neighbor nodes of the first node determined from the relation network of time instance t2 include node 3, node 4, node 5, and node 1, which constitute a neighbor node group of time instance t2. The neighbor nodes of the first node determined from a third relation network include node 3, node 4, node 5, and node 6, which constitute a neighbor node group of time instance t3.

When the neighbor nodes of the first node is to be determined in the relation networks, the determination may be performed according to a preset neighbor rule, and the neighbor rule may include a limitation on the neighbor order and/or the total number of neighbor nodes. In some embodiments, the neighbor nodes may be determined by the preset neighbor order, and the total number of neighbor nodes may also be preset. In some embodiments, the neighbor nodes may be determined according to the following neighbor rule: the neighbor order is limited to less than 3, and the maximum total number of neighbor nodes is 20. The neighbor order refers to the number of separated nodes on a connection path between a certain node and the first node. In some embodiments, if the number of separated nodes is 0, the node is directly connected to the first node, making this node the first-order neighbor of the first node. If the number of separated neighbors is 1, one node is present between the node and the first node, and the node is the second-order neighbor of the first node. Various similar examples exist, and are not elaborated herein.

The numbers of neighbor nodes of the first node respectively determined from the N relation networks may be different.

Step S230 is determining, for any first time instance among the N time instances, a spatial aggregation feature of the first node at the first time instance, based on a node feature of each neighbor node in a neighbor node group corresponding to the first time instance and a node feature of the first node. The spatial aggregation feature may be expressed in the form of a multi-dimensional vector. For each of the N time instances, the spatial aggregation feature of the first node at that time instance is determined through the above-described techniques. The “first” in the afore-mentioned first time instance and the corresponding “first” below are for the convenience of distinction and description, and shall not be limiting in any way.

The node feature of each neighbor node and the node feature of the first node are the initial features of the nodes, and may be expressed in the form of a multi-dimensional vector. In some embodiments, when the nodes represent users, the initial features of the nodes may include the following user features: basic attribute features, historical activity features, association relationship features, interaction features, physical indicator features, etc. When the nodes represent products, the initial features of the nodes may include basic attribute features of the products, circulation features of the products, etc. When the nodes represent shops or regions, the initial features of the nodes may include basic attribute features of the shops or regions, and the like.

The spatial aggregation feature of the first node at the first time instance may be determined in various methods. In some embodiments, feature aggregation may be directly performed on the node feature of each neighbor node in the neighbor node group corresponding to the first time instance and the node feature of the first node to obtain the spatial aggregation feature of the first node at the first time instance. Feature aggregation, for example, may be the average value or weighted average value of the node feature of each node. Other more effective and accurate methods may be employed to determine the spatial aggregation feature, and will be described herein.

Step S240 is inputting, in accordance with a temporal order, N spatial aggregation features of the N time instances into a sequential neural network as a sequence, and determining, at least based on an output result of the sequential neural network, N spatio-temporal expressions of the first node at the N time instances. The sequential neural network is used to determine, according to a trained model parameter(s) and the inputted sequence, the aggregation feature of the first node at each time instance as an output result. The aggregation feature may be expressed in the form of a multi-dimensional vector.

The N spatial aggregation features of the N time instances are combined into the sequence in accordance with the temporal order; for example, the spatial aggregation features of the time instances are sorted in accordance with the time from the earliest to the latest to obtain the sequence.

In some embodiments, there are three spatial aggregation features z1, z2, and z3 of three time instances t1, t2, and t3; and the spatial aggregation features z1, z2, and z3 arranged in accordance with the temporal order are inputted into the sequential neural network as a sequence to obtain an aggregation feature h1 of time instance t1, an aggregation feature h2 of time instance t2, and an aggregation feature h3 of time instance t3 outputted by the sequential neural network.

When the sequential neural network determines the aggregation feature of each time instance, the aggregation feature of any time instance may be obtained through aggregation based on the spatial aggregation features of one or more time instances before the time instance. In some embodiments, the aggregation feature of time instance t1 may be obtained based on aggregating the initial feature and the spatial aggregation feature z1 of time instance t1, and the initial feature may be preset or randomly generated. The aggregation feature of time instance t2 may be obtained based on aggregating the aggregation feature z1 of time instance t1 and the spatial aggregation feature z2 of time instance t2. The aggregation feature at time instance t3 may be obtained based on aggregating the aggregation feature z1 of time instance t1, the aggregation feature z2 of time instance t2, and the spatial aggregation feature z3 of time instance t3; and the aggregation feature of each subsequent time instance may be derived in a similar manner. The aggregation may be performed by obtaining an average value or a weighted average value, or through other aggregation algorithms.

The spatio-temporal expression may be a multi-dimensional vector. Determining the N spatio-temporal expressions may be performed in various methods. In some embodiments, the N aggregation features of the first node at the N time instances outputted by the sequential neural network may be directly used as the N spatio-temporal expressions. These N aggregation features may also be used as N temporal aggregation features; and the spatial aggregation features and the temporal aggregation features of the N time instances are correspondingly combined to respectively obtain the spatio-temporal expressions of the corresponding time instances. In the illustrated embodiment, the N temporal aggregation features of the first node at the N time instances are determined through the sequential neural network, and the temporal aggregation feature of any one of the time instances is obtained based on aggregating the spatial aggregation features of one or more time instances before the time instance.

In one implementation, the sequential neural network may be implemented by improving a long short-term memory (LSTM) or a recurrent neural network (RNN). In some embodiments, after one sequence is inputted into an LSTM or RNN, the output may be employed as one aggregation feature for each time instance, i.e., the temporal aggregation feature of said time instance. An LSTM is taken as an example to illustrate its application in this embodiment. In this embodiment, the LSTM may use the following calculations to determine the temporal aggregation feature of each time instance:

iᵤ^{m}=σ(W_{ω}_{ᵢ}CONCAT(hᵤ^{m-1},zᵤ^{m}))

fᵤ^{m}=σ(W_{ω}_{_{f}}CONCAT(hᵤ^{m-1},zᵤ^{m}))

oᵤ^{m}=σ(W_{ω}_{ₒ}CONCAT(hᵤ^{m-1},zᵤ^{m}))

cᵤ^{m}=fᵤ^{m}⊙cᵤ^{m-1}+iᵤ^{m}⊙ tanh(W_{c} CONCAT(hᵤ^{m-1},zᵤ^{m}))

hᵤ^{m}=oᵤ^{m}⊙ tanh(cᵤ^{m})

where zᵤ^{m} is a spatial aggregation feature of node u at time instance m; hᵤ^{m} is a temporal aggregation feature of node u at time instance m; hᵤ^{m-1} is a temporal aggregation feature of node u at time instance (m−1), and node u may be, for example, a first node. At the first time instance, hᵤ^{m-1} may be a random value or a preset value; ⊙ is a dot product function in the element-wise product; W_{ω}_{ᵢ}, W_{ω}_{_{f}}, W_{ω}_{ₒ}, and W_{c} are all model parameters, and are also to-be-trained parameters of training nodes; and CONCAT, tanh, and a are all functions in the LSTM.

The correspondingly combining the spatial aggregation features and temporal aggregation features of the N time instances to respectively obtain the spatio-temporal expressions of the corresponding time instances may be concatenating the spatial aggregation feature and temporal aggregation feature of any time instance in accordance with a preset method, and the corresponding feature obtained from the concatenation is used as a spatio-temporal expression of the corresponding time instance. The preset method may be, for example, placing the spatial aggregation feature in front of or behind the temporal aggregation feature, and the like. The vector dimensions of the spatio-temporal expression obtained in such method is the sum of the vector dimensions of the spatial aggregation feature and the temporal aggregation feature.

In some embodiments, the following equation may be used to concatenate the spatial aggregation feature and temporal aggregation feature:

rᵤ^{m}=CONCAT(zᵤ^{m},hᵤ^{m})

where zᵤ^{m} is a spatial aggregation feature of node u at time instance m; hᵤ^{m} is a temporal aggregation feature of node u at time instance m; rᵤ^{m} is a spatio-temporal expression of node u at time instance m; and CONCAT is a connection function.

In the above-described operation, the sequential neural network is used to model spatial information and generate the aggregation features as snapshots at different time instances. In other words, the combination of the spatial information and temporal information is achieved. If the aggregation feature outputted by the sequential neural network is used as a temporal dimension feature (temporal aggregation feature), combining the temporal dimension feature with the spatial dimension feature (spatial aggregation feature) would yield a more accurate spatio-temporal expression for each time instance.

Step S250 is aggregating the N spatio-temporal expressions to obtain a spatio-temporal aggregation feature of the first node as feature information of a first object represented by the first node. The spatio-temporal aggregation feature of the first node is a deep-level feature that combines the temporal dimension features and spatial dimension features extracted from the relation networks of multiple time instances. Using the spatio-temporal aggregation feature as the feature information of the first object causes the feature expression of the first object to be more relevant and accurate. If the feature expression of the first object is more accurate and relevant, other applications based on the feature information of the first object, such as object classification, information pushing, prediction, etc., would also have improved relevance and accuracy.

Aggregating the N spatio-temporal expressions may be performed with various methods, for example, using an average value or weighted average value. In addition, the N spatio-temporal expressions may also be aggregated based on a self-attention mechanism. One example method below may be adopted for aggregating the N spatio-temporal expressions based on a self-attention mechanism, and may include steps 1 to 4 as follows.

Step 1 is constructing a spatio-temporal expression matrix from the N spatio-temporal expressions. In some embodiments, the number of vector dimensions of each spatio-temporal expression is M, and M is an integer greater than 1. Each spatio-temporal expression may be used as a row vector of a spatio-temporal expression matrix, and the spatio-temporal expression matrix is an N by M matrix. Each spatio-temporal expression may also be used as a column vector of the spatio-temporal expression matrix, and the spatio-temporal expression matrix is an M by N matrix.

Step 2 is determining an attention matrix based on the self-attention mechanism and the N spatio-temporal expressions.

An exemplary process may include determining an attention value between any two spatio-temporal expressions. For example, vector dot multiplication may be directly performed on any two spatio-temporal expressions to obtain the attention value between every two spatio-temporal expressions. The attention matrix is constructed through multiple attention values. In addition, the Q, K, and V matrices may also be used to calculate the attention values of the N spatio-temporal expressions for constructing the attention matrix, and all of the Q, K, and V matrices may be matrix parameters obtained through pre-training.

Step 3 is obtaining a second transformation matrix based on a product of the attention matrix and a first transformation matrix, the first transformation matrix being a product of the spatio-temporal expression matrix and a pre-trained first parameter matrix. The second transformation matrix contains the self-attention mechanism-processed spatio-temporal expression of each time instance.

In some embodiments, based on steps 1 to 3 described above, the following equation may be used to determine the second transformation matrix:

$${X}_{v} = {β}_{v} ( {R}_{v} {W}_{v} ) \\ {β}_{v}^{ij} = \frac{exp ( {e}_{v}^{ij} )}{{Σ}_{k} exp ( {e}_{v}^{i k} )} \\ {e}_{v}^{ij} = \frac{{( ( {R}_{v} {W}_{q} ) {( {R}_{v} {W}_{k} )}^{T} )}_{ij}}{\sqrt{{F}^{′}}}$$

where Xᵥ is a second transformation matrix; Rᵥ is a spatio-temporal expression matrix; W_{q}, Wₖ, and Wᵥ respectively represent the Q, K, and V matrices, which are also the to-be-trained parameters in the training phase; Wᵥ is the above-mentioned first parameter matrix; RᵥWᵥ is a first transformation matrix; Rᵥ is an attention matrix; βᵥ^{ij} represents an element in the i-th row and j-th column of the attention matrix; the range of k includes each of the N time instances; the superscript ik indicates an element in the i-th row and k-th column; the superscript for eᵥ^{ij} in the numerator corresponds to an element in the i-th row and the j-th column; the parenthesis portion with the subscript ij represents an element in the i-th row and j-th column of the matrix; and F′ in the denominator is (a+b) obtained based on the order a*b of the matrix Xᵥ. Since the matrix order of βᵥ and Wᵥ may be preset, the order of Xᵥ is also preset, and the value of F′ is therefore preset, which has the effect of stabilizing the calculation result. exp is the exponential function that uses the natural constant e as the base; and exp(x) represents the natural constant e to the power of x. T is a matrix transpose symbol.

Step 4 is obtaining, based on concatenation of every vector in the second transformation matrix, the spatio-temporal aggregation feature of the first node. The multiple vectors of the second transformation matrix may be successively concatenated to obtain the spatio-temporal aggregation feature of the first node. In some embodiments, the following equation may be used to concatenate every vector in the second transformation matrix:

fᵥ^{u}=W_{F}CONCAT(Xᵥ¹,Xᵥ²,Xᵥ³, . . . ,Xᵥ^{H})

where fᵥ^{u} is the spatio-temporal aggregation feature of node u; W_{F} is a trained parameter matrix, which is a to-be-trained parameter during the training process; and Xᵥ^{H} is the H-th row vector in the second transformation matrix. The row vectors in the second transformation matrix are sequentially concatenated together and dot multiplied by the trained parameter to obtain the spatio-temporal aggregation feature of the first node.

In the above-described embodiments, each spatio-temporal expression in the spatio-temporal expression matrix is used as a row vector to calculate the second transformation matrix; and the spatio-temporal aggregation feature of the first node is obtained based on concatenation of all row vectors in the second transformation matrix. When each spatio-temporal expression is used as a column vector to constitute a spatio-temporal expression matrix, the spatio-temporal aggregation feature of the first node may be obtained based on concatenation of all column vectors in the second transformation matrix.

In some embodiments, other methods in the self-attention mechanism may also be adopted to determine an attention value between any two spatio-temporal expressions based on the N spatio-temporal expressions. Multiple attention values are used to process the N spatio-temporal expressions in accordance with a preset method; and the processed spatio-temporal expressions are aggregated to obtain the spatio-temporal aggregation feature of the first node.

In step S230 described above, the spatial aggregation feature of the first node at each of the N time instances is determined, which means that the spatial dimension feature of each time instance is determined. From steps S240 to S250, the spatial dimension feature of each time instance is aggregated on the temporal dimension, which is a process of aggregating different embedding vectors in a time series. The above-described processing is performed to achieve the goal of aggregating node features in both spatial and temporal dimensions, thereby acquiring feature information of nodes.

In some embodiments, the step of determining the spatial aggregation feature of the first node at the first time instance in step S230 may be performed for any first time instance among the N time instances by inputting the node feature of each neighbor node in the neighbor node group corresponding to the first time instance and the node feature of the first node into a graph neural network to obtain the spatial aggregation feature of the first node at the first time instance. The graph neural network is used to determine the spatial aggregation feature of the first node according to a model parameter(s) and the inputted node feature of each neighbor node and the node feature of the first node.

The above-mentioned graph neural network may be implemented by using a graph convolutional network (GCN), a graph attention network (GAN), a GraphSage graph neural network, or a Geniepath graph neural network.

The following provides an example implementation for determining the spatial aggregation feature of the first node at the first time instance. The implementation includes steps a to c as follows.

Step a is determining, through an attention mechanism-based adaptive breadth function and based on the node feature of each neighbor node in the neighbor node group corresponding to the first time instance and the node feature of the first node, an importance level of each neighbor node relative to the first node. In a relation network, for node y, importance levels of different neighbor nodes are different, and the importance level of each neighbor node may be calculated according to a certain mechanism.

In a relation network G, G=(V, E), where V represents a set of all nodes, and E represents a set of all connecting edges. For node y, the importance level a of node x may be determined through the following equations:

$$α ( x , y ) = {softmax}_{x , y} ( {v}^{T} tanh ( {W}_{s}^{T} x + {W}_{d}^{T} y ) ) \\$$

$${softmax}_{x , y} = \frac{{v}^{T} tanh ( {W}_{s}^{T} x + {W}_{d}^{T} y )}{{\sum }_{( {x}^{′} , y ) ∈ E} {v}^{T} tanh ( {W}_{s}^{T} {x}^{′} + {W}_{d}^{T} y )}$$

where x and y in the equations respectively represent the node features of nodes x and y. Wₛ^{T} and W_{d}^{T} are feature transformation matrices between nodes x and y, and are parameters obtained through training; v^{T} is an attention transformation vector and is also a parameter obtained through training; softmax is a normalization function; and (x′, y)∈E represents the nodes x′ connected to node y in the relation network. If node y represents the first node, each neighbor node in the neighbor node group at the first time instance may be taken as an individual node x; and nodes x′ include each neighbor node.

Step b is performing, based on the importance level corresponding to each neighbor node, weighted summation on the node feature of each neighbor node to obtain a breadth feature of the first node. The importance level is used as the weight of the corresponding neighbor node, and may be involved in the operation of weighted summation for the node feature of each neighbor node.

Step c is performing, through a loop operator-based adaptive depth function, t-step iterations on the first node based on the breadth feature to obtain the spatial aggregation feature of the first node at the first time instance. The result of the t-th iteration is obtained from aggregating the (t−1)-th results of the first node and of neighbor nodes of the first node. After the breadth feature of the first node is determined, a depth feature of the first node may be further extracted, making the spatial aggregation feature of the first node more relevant and accurate.

For example, the above-mentioned loop operator may be implemented through an LSTM operator or an RNN operator. Below the LSTM operator is used as an example to illustrate an exemplary iterative process. In this implementation, the cell state of the first node at each iteration is maintained, a structure similar to the LSTM is used to fuse the results of t-step iterations; and the structure includes three components: an input gate, a forget gate, and an output gate.

First, the input gate is used to select important information of the t-th iteration result:

i^{(t)}=σ(Wᵢ^{(t)T}CONCAT(z^{(t-1)},μ^{(t)})).

Then, the forget gate discards useless information in the previous cell state:

f^{(t)}=σ(W_{f}^{(t)T}CONCAT(z^{(t-1)},μ^{(t)})).

The output gate selects useful information in the (t+1)-th iteration, and the expression is as follows:

o^{(t)}=σ(Wₒ^{(t)T}CONCAT(z^{(t-1)},μ^{(t)})).

Finally, the hidden state is expressed as follows:

c^{(t)}=f^{(t)}⊙c^{(t-1)}+i^{(t)}⊙ tanh(W_{c}CONCAT(z^{(t-1)},μ^{(t)})).

The iteration result of the t-th iteration is:

z^{(t)}=o^{(t)}⊙ tanh(c^{(t)})

where μ^{(t)} refers to a breadth feature of the first node; z^{(t-1)} represents an iteration result obtained in the (t−1)-th iteration; and the superscript (t) represents a quantity in the t-th iteration. z^{(t)} represents an iteration result obtained in the t-th iteration, which is the spatial aggregation feature of the first node at the first time instance. Wᵢ^{(t)T} is a parameter of the input gate; W_{f}^{(t)T} is a parameter of the forget gate; Wₒ^{(t)T} is a parameter of the output gate; and W_{c} is a parameter in the hidden state. The above-mentioned parameters are obtained through training. T is a matrix transpose symbol; CONCAT is a connection function; CONCAT, tanh, and a are functions in LSTM; and ⊙ is an element-wise dot multiplication function.

The above-described implementation for determining the spatial aggregation feature of the first node at the first time instance may be included in a graph neural network. In exemplary applications, other methods may also be used to determine the spatial aggregation feature, which will not be further elaborated herein.

The foregoing embodiments provide the acquisition method for spatio-temporal aggregation-based object feature information. After feature information of objects is acquired, the information may have various applications in different aspects. In some embodiments, the information may be used in classifying objects, pushing information, or in predicting link relationships, and the like. Each is described separately in conjunction with embodiments below.

FIG. 3 is a schematic flowchart of a spatio-temporal aggregation-based object classification method provided by an embodiment. The method is executable by a computer, and the computer may be implemented by any device, platform, or device cluster having computing and processing capacities. The method includes the following steps.

Step S310 is acquiring feature information of a second object, wherein the second object is acquired through the method described in FIG. 2.

Step S320 is inputting the feature information of the second object into a pre-trained object classifier to obtain a classification result of the second object. The object classifier is used to determine, for the inputted feature information, a category to which the object belongs, and obtain the classification result. In some embodiments, the categories of the objects may include whether an object is a high-risk user or a low-risk user, or a target user or a non-target user for a certain event, etc. In some embodiments, the object classifier may be implemented as a linear classifier, such as a decision tree classifier, random forest classifier, etc., may be implemented as a fully connected function, or may be implemented as a multi-layer perceptron (MLP).

In this embodiment, given that the determined feature information of the second object is more relevant and accurate, the classification performed on the second object based on the feature information of the second object will also be more accurate, thereby improving the classification accuracy.

FIG. 4 is a schematic flowchart of a spatio-temporal aggregation-based information pushing method provided by an embodiment. The method is executable by a computer, and the computer may be implemented by any device, platform, or device cluster having computing and processing capacities. The method includes the following steps.

Step S410 is acquiring feature information of a third object and feature information of a fourth object, the feature information of the third object and the feature information of the fourth object being separately acquired through the method described in FIG. 2.

Step S420 is pushing, if a similarity level between the feature information of the third object and the feature information of the fourth object is greater than a preset similarity threshold, information to the fourth object based on information of interest for the third object. The preset similarity threshold may be a preset value determined empirically.

When the similarity level between the feature information of the third object and the feature information of the fourth object is to be determined, vector dot multiplication of the two pieces of feature information may be performed to obtain the similarity level. The similarity level may also be obtained through calculating the Euclidean distance, Jaccard coefficient, or Pearson correlation coefficient of the two pieces of feature information.

If the above-described similarity level is greater than the preset similarity threshold, the third object and the fourth object are considered to have similar objects of interest. Therefore, information may be pushed to the fourth object based on information of interest for the third object. In some embodiments, the objects may include a user, and information may be pushed to one user based on information of interest for another user. The information of interest may comprise product information, shop information, work products, or other information that may be pushed.

In this embodiment, given that an object is characterized through the more accurate and relevant feature information, pushing information to suitable objects based on the feature information of the objects may also be performed more accurately, thereby improving the accuracy of information pushing.

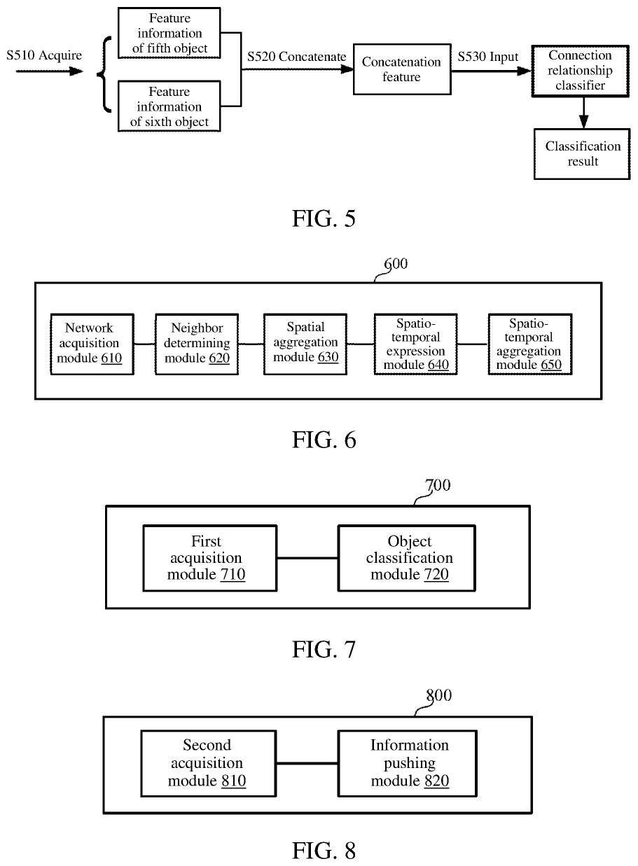

FIG. 5 is a schematic flowchart of a spatio-temporal aggregation-based connection relationship predicting method provided by an embodiment. The method is executable by a computer, and the computer may be implemented by any device, platform, or device cluster having computing and processing capacities. The method includes the following steps.

Step S510 is acquiring feature information of a fifth object and feature information of a sixth object, the feature information of the fifth object and the feature information of the sixth object being separately acquired through the method described in FIG. 2.

Step S520 is concatenating the feature information of the fifth object and the feature information of the sixth object to obtain a concatenation feature. In some embodiments, the two pieces of feature information may be concatenated as vectors in accordance with a preset concatenation rule. In some embodiments, the vector corresponding to the feature information of the fifth object may be placed in front of or behind the vector corresponding to the feature information of the sixth object to obtain the concatenation feature.

Step S530 is inputting the concatenation feature into a pre-trained connection relationship classifier to obtain a classification result of whether a connection relationship exists between the fifth object and the sixth object. The connection relationship classifier is used to determine, for the inputted concatenation feature, whether a connection relationship exists between the fifth object and the sixth object. The connection relationship may indicate a friend relationship, a buying-and-selling relationship, an affiliation relationship, and the like between the fifth object and the sixth object.

The connection relationship classifier may be implemented as a linear classifier, such as a decision tree classifier, random forest classifier, etc., may be implemented as a fully connected function, or may be implemented as an MLP.

In this embodiment, given that an object is characterized through the more accurate and relevant feature information, connection relationship prediction based on the feature information of the object may also be performed more accurately, thereby improving the prediction accuracy.

The sequential neural network involved in the foregoing embodiments may be pre-trained. In some embodiments, the method shown in FIG. 2 may be combined with those shown in FIG. 3, FIG. 4, or FIG. 5 for training. In some embodiments, the method shown in FIG. 2 is combined with the method shown in FIG. 3, and the process of steps S210 to S230 is adopted (using a sample node as the first node) to determine N spatial aggregation features of the sample node at N time instances; the N spatial aggregation features are inputted into a sequential neural network as a sequence in accordance with a temporal order; spatio-temporal expressions of the sample node at the N time instances are determined at least based on an output result of the sequential neural network; the N spatio-temporal expressions are aggregated to determine feature information of the sample node; the feature information of the sample node is inputted into an object classifier to obtain a predicted classification result of the sample node; a prediction loss value is determined according to the difference between the predicted classification result and labeled classification of the sample node; and a model parameter in the sequential neural network is updated in the direction of reducing the prediction loss value. During a training process, various parameters involved in FIG. 2 that need to be trained may also be adjusted. If the object classifier has a to-be-trained parameter, the parameter in the object classifier may also be adjusted. A trained classifier may also be directly adopted for the object classifier. The above-described training process may be performed iteratively until the training process converges.

The process of combining the method shown in FIG. 2 with the method shown in FIG. 4 or FIG. 5 for training is similar to the above-described training process and will not be further elaborated.

The above content describes exemplary embodiments of this specification. Other embodiments are within the scope of the appended claims. In some cases, the actions or steps recited in the claims may be performed in a sequence different from those in the embodiments and the desired result may still be achieved. In addition, the processes illustrated in the accompanying drawings are not required to be performed in the order or consecutive order as shown to achieve the desired result. In some embodiments, multi-tasking and concurrent processing are also feasible or may be advantageous.

FIG. 6 is a schematic block diagram of a spatio-temporal aggregation-based object feature information acquisition device provided by an embodiment. The device 600 may be implemented in a computer, and the device embodiment corresponds to the method embodiment shown in FIG. 2. The device 600 comprises a network acquisition module 610, a neighbor determining module 620, a spatial aggregation module 630, a spatio-temporal expression module 640, and a spatio-temporal aggregation module 650.

The network acquisition module 610 is configured to acquire N relation networks of N time instances, the relation networks comprising a plurality of nodes and connection relationships between the nodes, the N relation networks each comprising a first node, and the nodes representing objects.

The neighbor determining module 620 is configured to respectively determine, in the N relation networks, a plurality of neighbor nodes of the first node, and obtaining N neighbor node groups respectively corresponding to the N time instances for the first node.

The spatial aggregation module 630 is configured to determine, for any first time instance among the N time instances, a spatial aggregation feature of the first node at the first time instance based on a node feature of each neighbor node in a neighbor node group corresponding to the first time instance and a node feature of the first node.

The spatio-temporal expression module 640 is configured to input, in accordance with a temporal order, N spatial aggregation features of the N time instances into a sequential neural network as a sequence, and determine, at least based on an output result of the sequential neural network, N spatio-temporal expressions of the first node at the N time instances.

The spatio-temporal aggregation module 650 is configured to aggregate the N spatio-temporal expressions to obtain a spatio-temporal aggregation feature of the first node as feature information of a first object represented by the first node.

In some embodiments, the spatial aggregation module 630 is further configured to: input the node feature of each neighbor node in the neighbor node group corresponding to the first time instance and the node feature of the first node into a graph neural network to obtain the spatial aggregation feature of the first node at the first time instance.

In some embodiments, the spatial aggregation module 630 is further configured to: determine, through an attention mechanism-based adaptive breadth function and based on the node feature of each neighbor node in the neighbor node group corresponding to the first time instance and the node feature of the first node, an importance level of each neighbor node relative to the first node; perform, based on the importance level corresponding to each neighbor node, weighted summation on the node feature of each neighbor node to obtain a breadth feature of the first node; and perform, through a loop operator-based adaptive depth function, t-step iterations on the first node based on the breadth feature to obtain the spatial aggregation feature of the first node at the first time instance.

In some embodiments, when determining, at least based on the output result of the sequential neural network, the N spatio-temporal expressions of the first node at the N time instances, the spatio-temporal expression module 640 is further configured to perform the following operation: determining, through the sequential neural network, N temporal aggregation features of the first node at the N time instances; and correspondingly combining the spatial aggregation features and the temporal aggregation features of the N time instances to respectively obtain the spatio-temporal expressions of the corresponding time instances.

In some embodiments, when correspondingly combining the spatial aggregation features and the temporal aggregation features of the N time instances, the spatio-temporal expression module 640 is further configured to perform the following operation: concatenating, in accordance with a preset method, a spatial aggregation feature and a temporal aggregation feature of any time instance, and using a corresponding feature obtained from the concatenation as a spatio-temporal expression of the corresponding time instance.

In some embodiments, the spatio-temporal aggregation module 650 is further configured to aggregate the N spatio-temporal expressions based on a self-attention mechanism.

In some embodiments, when aggregating the N spatio-temporal expressions based on the self-attention mechanism, the spatio-temporal aggregation module 650 is further configured to perform the following operations: constructing a spatio-temporal expression matrix from the N spatio-temporal expressions; determining an attention matrix based on the self-attention mechanism and the N spatio-temporal expressions; obtaining a second transformation matrix based on a product of the attention matrix and a first transformation matrix, the first transformation matrix being a product of the spatio-temporal expression matrix and a pre-trained first parameter matrix; and determining, based on concatenation of each vector in the second transformation matrix, the spatio-temporal aggregation feature of the first node.

In some embodiments, the graph neural network includes a GCN, a GAN, a GraphSage network, or a Geniepath network.

In some embodiments, the sequential neural network includes an LSTM or RNN.

In some embodiments, the objects include at least one of the following types: a user, a product, a shop, and a region.

In some embodiments, a temporal aggregation feature of any one of the time instances is obtained based on aggregating the spatial aggregation features of one or more time instances before said time instance.

FIG. 7 is a schematic block diagram of a spatio-temporal aggregation-based object classification device provided by an embodiment. The device 700 is implemented in a computer, and the device embodiment corresponds to the method embodiment shown in FIG. 3. The device 700 comprises: a first acquisition module 710 and an object classification module 720.

The first acquisition module 710 is configured to acquire feature information of a second object obtained, wherein the feature information of the second object is acquired through the method described in FIG. 2.

The object classification module 720 is configured to input the feature information of the second object into a pre-trained object classifier to obtain a classification result of the second object.

FIG. 8 is a schematic block diagram of a spatio-temporal aggregation-based information pushing device provided by an embodiment. The device 800 is implemented in a computer, and the device embodiment corresponds to the method shown in FIG. 4. The device 800 comprises: a second acquisition module 810 and an information pushing module 820.

The second acquisition module 810 is configured to acquire feature information of a third object and feature information of a fourth object, the feature information of the third object and the feature information of the fourth object being separately acquired through the method described using FIG. 2.

The information pushing module 820 is configured to push, if a similarity level between the feature information of the third object and the feature information of the fourth object is greater than a preset similarity threshold, information to the fourth object based on information of interest for the third object.

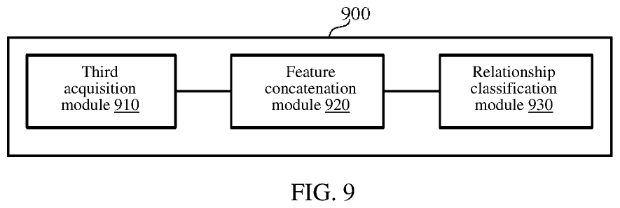

FIG. 9 is a schematic block diagram of a spatio-temporal aggregation-based connection relationship predicting device provided by an embodiment. The device 900 is implemented in a computer, and the device embodiment corresponds to the method embodiment shown in FIG. 5. The device 900 comprises: a third acquisition module 910, a feature concatenation module 920, and a relationship classification module 930.

The third acquisition module 910 is configured to acquire feature information of a third object and feature information of a fourth object, the feature information of the third object and the feature information of the fourth object being separately acquired through the method described using FIG. 2.

The feature concatenation module 920 is configured to concatenate the feature information of the fifth object and the feature information of the sixth object to obtain a concatenation feature.

The relationship classification module 930 is configured to input the concatenation feature into a pre-trained connection relationship classifier to obtain a classification result of whether a connection relationship exists between the fifth object and the sixth object.

The above-described device embodiments correspond to the method embodiments, and the description of the method embodiments may be referred to for details. Device embodiments will not be further elaborated herein. The device embodiments are obtained based on the corresponding method embodiments, and have the same technical effects as the corresponding method embodiments. The corresponding method embodiments may be referred to for details.

An embodiment of this specification further provides a computer-readable storage medium having a computer program stored thereon; and when the computer program is executed in a computer, the computer is caused to execute the method described in any one of FIGS. 1 to 5.

An embodiment of this specification further provides computing equipment comprising a memory and a processor. Executable code is stored in the memory, and when executing the executable code, the processor implements the method of any one of FIGS. 1 to 5.

The various embodiments in this specification are described in a progressive manner. The various embodiments may refer to other embodiments for the same or similar parts, and each of the embodiments focuses on the parts differing from the other embodiments. The storage medium and computing equipment embodiments are basically similar to the method embodiments. The description for these embodiments is thus relatively brief. The description of the method embodiments may be referred to for details.

Those skilled in the art should appreciate that in one or more of the foregoing examples, the functions described in the embodiments of this specification may be implemented by hardware, software, firmware, or any combination thereof. When implemented by software, these functions may be stored in a computer-readable medium or transmitted as one or more instructions or code on a computer-readable medium.

The techniques disclosed above describe, in further details, the objectives, technical solutions, and advantageous effects of the embodiments of this specification. It should be understood that the above descriptions are exemplary implementations of the embodiments of this specification, and are not used to limit the protection scope of this specification. Any modifications, equivalent alternatives, improvements, etc., made on the basis of the technical solutions of this specification shall be fall within the protection scope of this specification.

What is claimed is:

1. An object feature information acquisition method executable by a computer, the method comprising:
obtaining N relation networks of N time instances, wherein the N time instances have a temporal order, each of the relation networks corresponds to a time instance of the N time instances and comprises a plurality of nodes and connection relationships between the nodes, and each of the relation networks comprises a first node representing a first user;
determining (i) a spatial aggregation feature of the first node at a first time instance and (ii) a node feature of the first node, wherein the node feature of the first node comprises an attribute feature, a historical activity feature, an association relationship feature, an interaction feature, or a physical indicator feature;
inputting, in accordance with the temporal order, N spatial aggregation features of the N time instances into a sequential neural network;
determining, based on an output result of the sequential neural network, N spatio-temporal expressions of the first node at the N time instances; and
aggregating the N spatio-temporal expressions to obtain a spatio-temporal aggregation feature of the first node as feature information of the first user.

2. The method of claim 1, wherein determining the spatial aggregation feature of the first node at the first time instance comprises:
determining, in a relation network at the first time instance, a plurality of neighbor nodes of the first node at the first time instance as a first neighbor node group; and
inputting a node feature of each of the neighbor nodes in the first neighbor node group and the node feature of the first node into a graph neural network to obtain the spatial aggregation feature of the first node at the first time instance.

3. The method of claim 1, wherein determining the spatial aggregation feature of the first node at the first time instance comprises:
determining, in a relation network at the first time instance, a plurality of neighbor nodes of the first node at the first time instance as a first neighbor node group;
determining, through an attention mechanism-based adaptive breadth function and based on a node feature of each of the neighbor nodes in the first neighbor node group and the node feature of the first node, an importance level of each of the neighbor nodes relative to the first node;
performing, based on the importance level of each of the neighbor nodes, weighted summation on the node feature of each of the neighbor nodes to obtain a breadth feature of the first node; and
performing, through a loop operator-based adaptive depth function, t-step iterations on the first node based on the breadth feature to obtain the spatial aggregation feature of the first node at the first time instance.

4. The method of claim 1, wherein determining the N spatio-temporal expressions of the first node at the N time instances comprises:
determining, through the sequential neural network, N temporal aggregation features of the first node at the N time instances; and
combining the spatial aggregation features with the temporal aggregation features of the N time instances to obtain the spatio-temporal expressions of the first node.

5. The method of claim 4, wherein combining the spatial aggregation features with the temporal aggregation features of the N time instances comprises:
concatenating the spatial aggregation feature of the first time instance and a corresponding temporal aggregation feature of the first time instance to obtain a concatenation feature as a spatio-temporal expression of the first time instance.

6. The method of claim 1, wherein aggregating the N spatio-temporal expressions comprises:
constructing a spatio-temporal expression matrix from the N spatio-temporal expressions;
determining an attention matrix based on a self-attention mechanism and the N spatio-temporal expressions;
obtaining a second transformation matrix based on a product of the attention matrix and a first transformation matrix, the first transformation matrix being a product of the spatio-temporal expression matrix and a pre-trained first parameter matrix; and
determining, based on concatenation of each vector in the second transformation matrix, the spatio-temporal aggregation feature of the first node.

7. The method of claim 1, further comprising:
determining a feature information of a second user;
determining a similarity level between the feature information of the first user and the feature information of the second user; and
in response to the similarity level being greater than a threshold, sending information of interest of the second user to the first user, wherein the information of interest comprises one or more of product information, shop information, and work products.

8. The method of claim 1, further comprising:
determining a feature information of a second object represented by a second node;
concatenating the feature information of the first user and the feature information of the second object to obtain a concatenation feature; and
inputting the concatenation feature into a pre-trained connection relationship classifier to obtain a classification result of whether a connection relationship exists between the first user and the second object.

9. An object feature information acquisition device, comprising one or more processors and a non-transitory computer-readable memory coupled to the one or more processors and configured with instructions executable by the one or more processors to perform operations comprising:
obtaining N relation networks of N time instances, wherein the N time instances have a temporal order, each of the relation networks corresponds to a time instance of the N time instances and comprises a plurality of nodes and connection relationships between the nodes, and each of the relation networks comprises a first node representing a first user;
determining (i) a spatial aggregation feature of the first node at a first time instance and (ii) a node feature of the first node, wherein the node feature of the first node comprises an attribute feature, a historical activity feature, an association relationship feature, an interaction feature or a physical indicator feature;
inputting, in accordance with the temporal order, N spatial aggregation features of the N time instances into a sequential neural network;
determining, based on an output result of the sequential neural network, N spatio-temporal expressions of the first node at the N time instances; and
aggregating the N spatio-temporal expressions to obtain a spatio-temporal aggregation feature of the first node as feature information of the first user.

10. The device of claim 9, wherein determining the spatial aggregation feature of the first node at the first time instance comprises:
determining, in a relation network at the first time instance, a plurality of neighbor nodes of the first node at the first time instance as a first neighbor node group; and
inputting a node feature of each of the neighbor nodes in the first neighbor node group and the node feature of the first node into a graph neural network to obtain the spatial aggregation feature of the first node at the first time instance.

11. The device of claim 9, wherein determining the spatial aggregation feature of the first node at the first time instance comprises:
determining, in a relation network at the first time instance, a plurality of neighbor nodes of the first node at the first time instance as a first neighbor node group;
determining, through an attention mechanism-based adaptive breadth function and based on a node feature of each of the neighbor nodes in the first neighbor node group and the node feature of the first node, an importance level of each of the neighbor nodes relative to the first node;
performing, based on the importance level of each of the neighbor node, weighted summation on the node feature of each of the neighbor nodes to obtain a breadth feature of the first node; and
performing, through a loop operator-based adaptive depth function, t-step iterations on the first node based on the breadth feature to obtain the spatial aggregation feature of the first node at the first time instance.

12. The device of claim 9, wherein determining the N spatio-temporal expressions of the first node at the N time instances comprises:
determining, through the sequential neural network, N temporal aggregation features of the first node at the N time instances; and
combining the spatial aggregation features with the temporal aggregation features of the N time instances to obtain the spatio-temporal expressions of the first node, the combining comprising:
concatenating the spatial aggregation feature of the first time instance and a corresponding temporal aggregation feature of the first time instance to obtain a spatio-temporal expression of the first time instance.

13. The device of claim 9, wherein aggregating the N spatio-temporal expressions comprises:
constructing a spatio-temporal expression matrix from the N spatio-temporal expressions;
determining an attention matrix based on a self-attention mechanism and the N spatio-temporal expressions;
obtaining a second transformation matrix based on a product of the attention matrix and a first transformation matrix, the first transformation matrix being a product of the spatio-temporal expression matrix and a pre-trained first parameter matrix; and
determining, based on concatenation of each vector in the second transformation matrix, the spatio-temporal aggregation feature of the first node.

14. The device of claim 9, the operations further comprise:
determining a feature information of a second user;
determining a similarity level between the feature information of the first user and the feature information of the second user; and
in response to the similarity level being greater than a threshold, sending information of interest of the second user to the first user, wherein the information of interest comprises one or more of product information, shop information, and work products.

15. The device of claim 9, wherein the operations further comprise:
determining a feature information of a second object represented by a second node;
concatenating the feature information of the first user and the feature information of the second object to obtain a concatenation feature; and
inputting the concatenation feature into a pre-trained connection relationship classifier to obtain a classification result of whether a connection relationship exists between the first user and the second object.

16. A non-transitory computer-readable storage medium for object feature information acquisition, storing instructions executable by one or more processors to cause the one or more processors to perform operations comprising:
obtaining N relation networks of N time instances, wherein the N time instances have a temporal order, each of the relation networks corresponds to a time instance of the N time instances and comprises a plurality of nodes and connection relationships between the nodes, and each of the relation networks comprise a first node representing a first user;
determining (i) a spatial aggregation feature of the first node at a first time instance and (ii) a node feature of the first node, wherein the node feature of the first node comprises an attribute feature, a historical activity feature, an association relationship feature, an interaction feature or a physical indicator feature;
inputting, in accordance with the temporal order, N spatial aggregation features of the N time instances into a sequential neural network;
determining, based on an output result of the sequential neural network, N spatio-temporal expressions of the first node at the N time instances; and
aggregating the N spatio-temporal expressions to obtain a spatio-temporal aggregation feature of the first node as feature information of the first user.

17. The non-transitory computer-readable storage medium of claim 16, wherein determining the spatial aggregation feature of the first node at the first time instance comprises:
determining, in a relation network at the first time instance, a plurality of neighbor nodes of the first node at the first time instance as a first neighbor node group; and
inputting a node feature of each of the neighbor nodes in the first neighbor node group and the node feature of the first node into a graph neural network to obtain the spatial aggregation feature of the first node at the first time instance.

18. The non-transitory computer-readable storage medium of claim 16, wherein determining the spatial aggregation feature of the first node at the first time instance comprises:
determining, in a relation network at the first time instance, a plurality of neighbor nodes of the first node at the first time instance as a first neighbor node group;
determining, through an attention mechanism-based adaptive breadth function and based on a node feature of each of the neighbor nodes in the first neighbor node group and the node feature of the first node, an importance level of each of the neighbor nodes relative to the first node;
performing, based on the importance level of each of the neighbor nodes, weighted summation on the node feature of each of the neighbor nodes to obtain a breadth feature of the first node; and
performing, through a loop operator-based adaptive depth function, t-step iterations on the first node based on the breadth feature to obtain the spatial aggregation feature of the first node at the first time instance.

19. The non-transitory computer-readable storage medium of claim 16, wherein determining the N spatio-temporal expressions of the first node at the N time instances comprises:
determining, through the sequential neural network, N temporal aggregation features of the first node at the N time instances; and
combining the spatial aggregation features with the temporal aggregation features of the N time instances to obtain the spatio-temporal expressions of the first node, the combining comprising:
concatenating the spatial aggregation feature of the first time instance and a corresponding temporal aggregation feature of the first time instance to obtain a spatio-temporal expression of the first time instance.

20. The non-transitory computer-readable storage medium of claim 16, wherein aggregating the N spatio-temporal expressions comprises:
constructing a spatio-temporal expression matrix from the N spatio-temporal expressions;
determining an attention matrix based on a self-attention mechanism and the N spatio-temporal expressions;
obtaining a second transformation matrix based on a product of the attention matrix and a first transformation matrix, the first transformation matrix being a product of the spatio-temporal expression matrix and a pre-trained first parameter matrix; and
determining, based on concatenation of each vector in the second transformation matrix, the spatio-temporal aggregation feature of the first node.
